(19) United States
(12) Patent Application Publication
(10) Pub. No.: US 2010/0125507 A1
(43) Pub. Date: May 20, 2010

(54) Method and system for presenting sponsored content

(75) Inventors: Samuel Tarantino, III, Gainesville, FL (US); Josh Greenberg, Gainesville, FL (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Escape Media Group, Inc., Gainesville, FL (US)

(21) Appl. No.: 12/313,147

(22) Filed: Nov. 17, 2008

(51) Int. Cl. G06Q 30/00; G06F 17/30; G06Q 40/00

(52) U.S. Cl. 705/14.69; 707/E17.108; 705/37

(57) ABSTRACT

Content items of a mixed content pool, which includes sponsored and unsponsored content items, are identified as being relevant to a target content item that has been presented to or supplied by a user, and then the relevant content items are ranked. The ranking evaluates the bid amount, if any, of the relevant content items, and weights user acceptance of the relevant content items more heavily than any bid amount. A related content item determined from the ranking is then presented to the user.

### BACKGROUND OF THE INVENTION

Various internet websites provide for presentation of digital content, such as songs, movies, video games, etc., to users, who can access the websites from communication devices, such as home computers, PDAs, cell phones, etc. The websites typically provide that a user can specify a particular content item to be obtained by the website, and then the specified content item is presented by the website to the user after which the user can play or view, as suitable, the presented content item. Some websites, in addition, provide that a user can supply information to a website, or information can be derived by the website based on content items presented to the user, and that such information can be used by the website to retrieve content items likely to be of interest to the user (“recommended content items”), which are then presented to the user. The user, in turn, can then decide whether to play or view the recommended content items. For example, a user who desires to be presented with a certain genre of musical songs, such as rock and roll songs, can specify criteria, such as the name of a musician, the genre of the music, the time period during which a song was released, etc., and the website would retrieve and present to the user songs having attributes that are the same as or similar to the specified criteria.

Oftentimes, the author or distributor (sponsor) of a content item desires to expose the content item, as quickly as possible, to as many individuals as possible who are likely to be interested in the content item. Quick and widespread exposure is desirable to the sponsor, because this may increase sales of the content item, or other content of the sponsor. Currently, the sponsor of a content item can use advertising, such as banner advertisements on a webpage, to promote the content item. In addition, some websites present a newly available content item as a recommended content item to users who are determined likely to have an interest in such new content item, when user acceptance level for the new content item attains a threshold. The time that it takes for the new content item to be presented to a sufficiently large number of individuals to whom the new content item is likely to be of interest, however, still may be too long for its sponsor. In addition, the likelihood that the new content item would be presented to a sufficient number of individuals, such that a user acceptance level satisfies a threshold that should result in increased exposure for the new content item as a recommended content item, is unknown and uncertain.

Therefore, there exists a need for increasing the likelihood that a content item will be exposed more quickly to an increased number of individuals who are likely to find the new content item of interest.

### SUMMARY OF THE INVENTION

In accordance with one aspect of the present invention, content items relevant to a target content item presented to a user are identified by a processor, from a content pool including content items for which a sponsorship bid has been paid and unsponsored content items. The relevant content items are ranked by the processor evaluating user acceptance levels of the respective relevant content items and amounts of bids paid respectively for sponsored content items identified as the relevant content items. In ranking the relevant content items, the user acceptance level for a relevant content item receives greater weight than the amount of the bid for a relevant content item. Based on the ranking, a related content item is presented to the user subsequent to the presentation of the target content item, and the presentation can include rendering of the related content item to the user, such as playing or displaying the related content item to the user.

In one embodiment, a recommended bid price for sponsoring a content item can be determined by a processor and provided to a sponsor, where the determination can be based on (i) the number of sponsors bidding on a target content item; (ii) the popularity of a target content item; (iii) the number of presentations of the sponsored content item that are likely to occur over a defined time interval; (iv) the number of users expected to be presented with a target content item over a predetermined time interval; and (v) the specificity of the information to be used for targeting a content item.

In another embodiment, the sponsor, during bidding on a content item for sponsorship, can receive information on at least one property of a targeted content item, information on users to whom a target content item has been presented, and a suggestion of at least one content item for targeting.

In a further embodiment, the sponsorship status of a content item in the mixed content pool can be converted based on its user acceptance level or its frequency of presentation to users during a predetermined time interval.

In still another embodiment, the sponsored content items identified as the relevant content items for a target content item can be eliminated from consideration in the ranking if the number of the relevant sponsored content items exceeds a threshold.

In accordance with another aspect of the invention, content items relevant to a target search query of a user are identified by a processor, from a content pool including search result content items for which a sponsorship bid has been paid and unsponsored search result content items. In one embodiment, the unsponsored search result content items include at least one of (i) search results actually obtained from a search on the target search query by a search engine or (ii) search results for which a payment has been made to have the paid search results displayed on a webpage with the search results actually obtained from the search on the target search query. The relevant search result content items are ranked by the processor evaluating user acceptance levels of the respective relevant content items and amounts of bids paid respectively for sponsored content items identified as the relevant content items. In ranking the relevant content items, the user acceptance level for a relevant content item receives greater weight than the amount of the bid for a relevant content item. Based on the ranking, at least one related search result content item is presented to the user.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a block diagram of a system in accordance with an aspect of the present invention.

FIG. 2 is a block diagram of an exemplary embodiment of the system of FIG. 1.

FIG. 3 is a flow diagram of a process in accordance with an aspect of the present invention.

FIG. 4 is an exemplary screen display in accordance with an aspect of the present invention.

### DETAILED DESCRIPTION

For purposes of describing the method and system for presenting a content item likely to be of interest to a user, from a mixed content pool containing content items for which a sponsor has paid a bid to increase the likelihood that the content item is presented to the user (“sponsored content items”) and content items that are not sponsored (“unsponsored content items”), subsequent to the presentation of a given content item to the user in accordance with aspects of the present invention, the following definitions of terms is provided.

### DEFINITIONS

Mixed Content Pool: A collection of content items including sponsored content items and unsponsored content items.

Sponsor: A party interested in increasing the likelihood of presentation and engagement for its content item included within the mixed content pool, in exchange for money, goods, services or some other form of compensation.

Bidder: A sponsor who has placed a bid on a given content item.

Bid: An amount that a sponsor pays for a portion of the available opportunity for presentation resulting from the presentation of a given content item or set of content items.

Content Item: A single piece of content material that is the base unit for presentation within a mixed content pool.

Campaign: A period, selected by a bidder, in which a bid is in effect for a given content item or set of content items.

Sponsored Content: A content item in the mixed content pool that a bidder adds to a campaign to increase the likelihood of presentation and engagement of the content item.

Unsponsored Content: A content item in the mixed content pool that can be presented without the direct involvement of a sponsor of the content item.

New Content Item: A content item recently introduced into the mixed content pool which has an unverified external source, or which contains elements suggestive of a lack of proper identifying information or otherwise causing the content item to be distinguished from other content items in the mixed content pool.

Exposure: The presentation of a content item, or rendering of the presented content item, such as playing or displaying the content item, to a user.

Engagement: The rendering of a content item to a user, initiated by the user.

User: An individual to whom a content item selected from the mixed content pool can be presented.

Related Content Item: A content item from the mixed content pool that is presented to a user as a direct result of the user being presented or interacting with a preceding, target content item which is determined to be related to the presented content item.

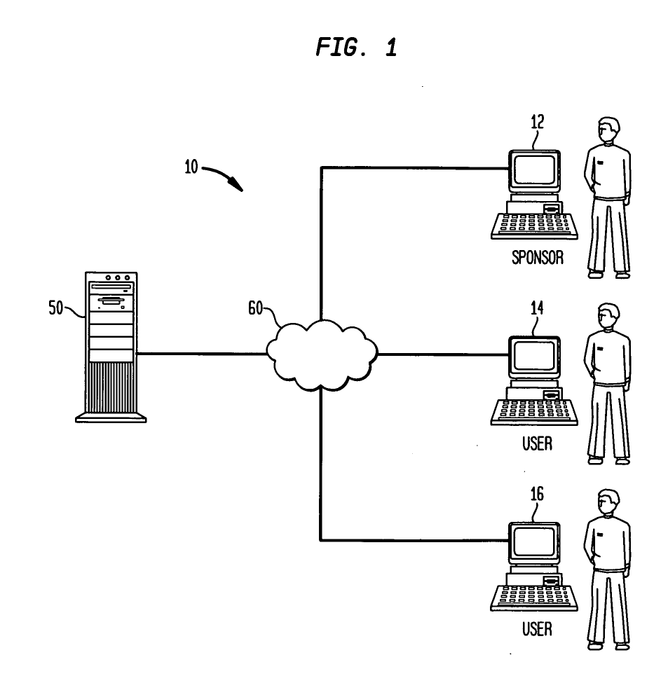

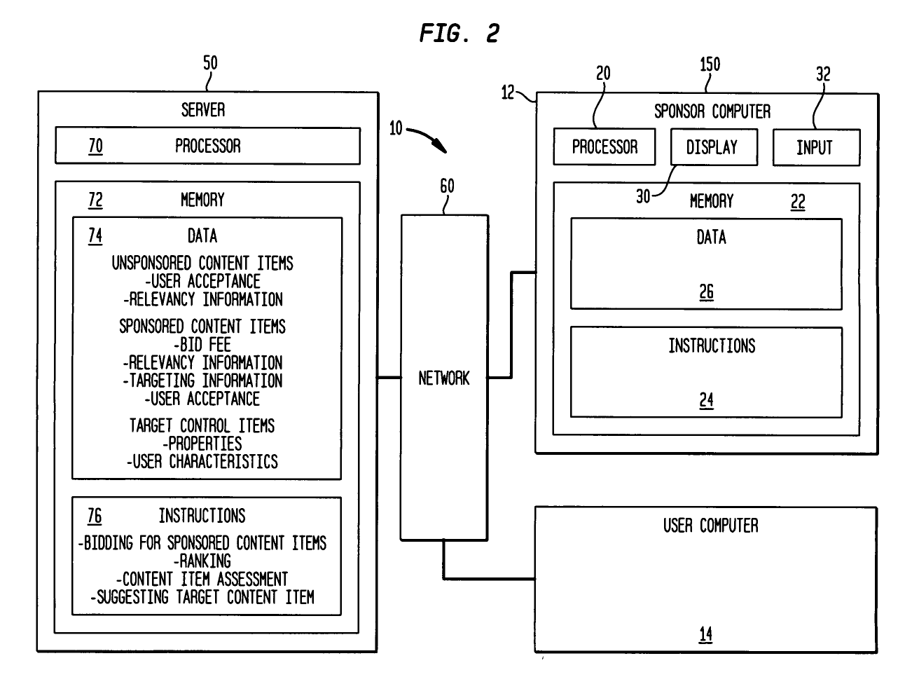

In accordance with one aspect of the invention and as shown in FIGS. 1 and 2, a content presentation system 10 can identify content items, from a mixed content pool containing sponsored and unsponsored content items, having a relevance to a target content item previously presented to a user; rank the relevant content items in view of any bids paid therefore and also user acceptance levels; and present to the user a related content item determined from the ranking of the relevant content items. The system 10 can include client computers 12, 14, 16, which are used by sponsors or users to communicate with a server computer 50 over a communication network 60. Each of the computers 12, 14, 16 contains a processor 20, memory 22 and other components typically present in general purpose computers. In addition, the server 50 contains a processor 70 and a memory 72.

The memory 22 stores information accessible by the processor 20, including instructions 24 that may be executed by the processor 20 and data 26 that may be retrieved, manipulated or stored by the processor 20. Similarly, the memory 72 stores information accessible by processor 70, including instructions 76 that may be executed by the processor 70 and data 74 that may be retrieved, manipulated or stored by the processor 70. The memory may be of any type capable of storing information accessible by the processor, such as a hard-drive, memory card, ROM, RAM, DVD, CD-ROM, write-capable, read-only memories.

The processors 20, 70 may comprise any number of well known processors, such as processors from Intel Corporation. Alternatively, the processors may be a dedicated controller such as an ASIC.

The instructions 24, 76 may comprise any set of instructions to be executed directly (such as machine code) or indirectly (such as scripts) by the processors 20, 70, respectively. In that regard, the terms “instructions,” “steps” and “programs” may be used interchangeably herein. The instructions may be stored in object code form for direct processing by the processor, or in any other computer language including scripts or collections of independent source code modules that are interpreted on demand or compiled in advance. The functions, methods and routines of instructions in accordance with the present invention are explained in more detail below.

The data 26, 74 may be retrieved, stored or modified by the processors 20, 70 in accordance with the instructions 24, 76, respectively. The data may be stored as a collection of data. For instance, although the invention is not limited by any particular data structure, the data may be stored in computer registers, in a relational database as a table having a plurality of different fields and records, XML documents, or flat files. The data may also be formatted in any computer readable format such as, but not limited to, binary values, ASCII or EBCDIC (Extended Binary-Coded Decimal Interchange Code). Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIGS. 1 and 2 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one embodiment, each client computer may be a general purpose computer, intended for use by a person, having all the internal components normally found in a personal computer such as a central processing unit (CPU), display 30, input 32 such as a CD-ROM drive, mouse, keyboard or microphone, and a hard-drive, speakers, modem and/or router (telephone, cable or otherwise) and all of the components used for connecting these elements to one another. Moreover, computers in accordance with the systems and methods described herein may comprise any device capable of processing instructions and transmitting data to and from humans and other computers, including network computers lacking local storage capability, PDAs with modems and Internet-capable wireless phones. Although the only input means shown in FIG. 1 are the mouse and keyboard, other means for inputting information from a human into a computer are also acceptable such as a microphone, touch-sensitive screen, voice recognition, etc.

The server 50 and the client computers 12, 14, 16 are capable of direct and indirect communication, such as over the network 60. Although only a few client computers and a single server are depicted in FIGS. 1 and 2, it should be appreciated that a typical system can include a large number of connected computers and several servers to which the computers can connect, with each different computer being at a different node of the network. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. In one embodiment, the server 50 may be a web server, and the client computers include browsers for facilitating communications with the server 50. Although certain advantages are obtained when information is transmitted or received as noted above, other aspects of the invention are not limited to any particular manner of transmission of information. For example, in some aspects, the information may be sent via a medium such as a disk, tape, CD-ROM.

The information may also be transmitted over a global or private network, or directly between two computer systems, such as via a dial-up modem. In other aspects, the information may be transmitted in a non-electronic format and manually entered into the system.

Referring to FIG. 2, the data 74 in the server 50 includes information relating to sponsored content items in a mixed content pool, such as bid paid for a sponsored content item; information for determining relevancy in relation to another content item; information for targeting a specific content item or set of content items; and user acceptance levels. In addition, the data 74 includes user acceptance levels and information for determining the relevancy of unsponsored content items in the mixed content pool. Further, the data 74 includes information of properties of a content item for which a related content item from the mixed content pool can be selected (“target content item”) and then presented to a user by the server 50, and characteristics of users to which the server 50 presents a target content item.

The instructions 76 can contain instructions that the processor 70 can execute to control creation of a sponsored content campaign, which includes determining and then providing to a sponsor a recommended bid price for a content item in a mixed content pool that the sponsor desires to convert into a sponsored content item; to rank content items from the mixed content pool identified as relevant to a target content item for determining a related content item to be presented to a user following the presentation of the target content item to the user; and to assess the status, such as popularity or user acceptance, of a content item in the mixed content pool and perform suitable actions, such as converting a sponsored content item to an unsponsored content item or providing alternative exposure mechanisms for a sponsored content item that likely would not have increased exposure based on sponsorship. The processor 70 performs the instructions in the memory 76 using the data 74, which includes information supplied by sponsors and information collected or created by the server 50 based on presentation of content items in the mixed content pool to users and engagement of the presented content items by users. In one embodiment, the content items in the mixed content pool can include content items targeted by sponsors.

In addition to the operations illustrated in FIGS. 1-2, operations in accordance with a variety of aspects of the inventive method will now be described. It should be understood that the following operations do not have to be performed in the precise order described below. Rather, various steps can be handled in reverse order or simultaneously.

In accordance with one aspect of the invention, content items of a mixed content pool are identified as sponsored and unsponsored content items and with information that can be used to determine the extent of relatedness between the content item and a target content item previously presented to a user, and the sponsorship and the information for determining the extent of relatedness are used in combination with information representative of a level of user acceptance of a content item to determine which of the content items identified as being relevant to the target content item to present to the user following the presentation of the target content item.

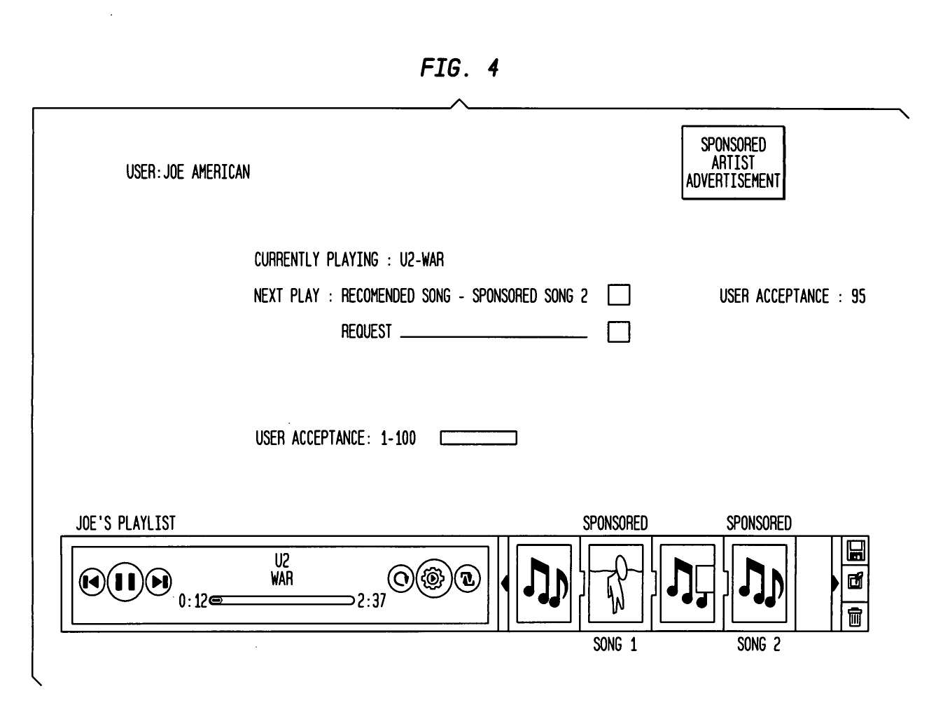

In one embodiment, the server 50 defines a mixed content pool that is continuously changing based on available content items that can be accessed by the server 50 over the network and then can be transmitted, such as by streaming, to users at the client computers 14, 16. For purposes of illustration, the,content items are audio songs which are stored on content websites and the server 50 can retrieve from the content websites for transmission to users, based on a licensing arrangement between the server 50 and the content websites. Alternatively, the content items are provided directly to the server 50 by respective sponsors and stored in the memory 72, where the sponsors permit the server 50 to present such content items to users, upon request by the user, or automatically based on a related content item determination by the processor 70 of the server 50 as discussed in detail below. For purposes of illustrating the inventive features, reference is made below to an exemplary screen display of a webpage shown in FIG. 4, where the display would be generated at a client computer being used by a user who is accessing the server 50. Referring to FIG. 4, the webpage includes a listing of the names of the audio songs presented to the user, in the order presented, with the song being played highlighted and with the related content items Sponsored Song 1 and Sponsored Song 2, as determined in accordance with aspects of the present invention, shown with a marking “sponsored” to indicate sponsorship and as being presented to the user immediately after the presentation of the songs of Violet Hill by Coldplay and War by U2, which are content items requested by the user and targeted by the Sponsored Song 1 and Sponsored Song 2, respectively. In an alternative embodiment, the related content items can be displayed to the user without any indication of sponsorship.

In alternative embodiments, the content items can be videos, electronic video games, publications, or any form of content that can be converted into a digital file for presentation to a user.

In one embodiment, a content item of the mixed content pool can become identified as a sponsored content item in the memory 74 of the server 50 by its sponsor using a computer, such as the client computer 12, to interact with the server 50 and create a sponsored content campaign. In the creation of a campaign, the sponsor can define targeting options. The targeting options can include the identification of specific content items to be targeted. In addition, a targeting option can include criteria to be used for selection of target content items. The criteria can include initial date of public distribution of a target content item; popularity, such as number of plays, views, downloads and/or subscriptions for a predetermined time interval or since the original date of distribution of the target content item; any type of metric that can describe a relationship between content items, such as genre of a song, mood associated with a song, how specific or to what extent the content item must be related to the target content item, such as a minimum level of popularity for the target content item, etc.; number of bids submitted by sponsors of content items to the server 50 for the available opportunities of presentation for a target content item; the maximum bid for a target content item; and the minimum bid for a target content item. In addition, the server 50 stores, as the data 74 in the memory 72, various data regarding content items targeted by sponsors. As discussed in detail below, a sponsor can pay a bid for a content item, thereby converting the unsponsored content item in the mixed content pool to a sponsored content item, to increase the likelihood that the sponsored content item would be presented to, and furthermore engaged by, a user following the presentation to the user of the content item targeted by the sponsor, thereby increasing the likelihood of exposure of the sponsored content item to users likely to have an interest in the sponsored content item.

In a further embodiment, the targeting options can include properties of users (“target users”) to which the target content item has been presented. The properties of the target users can include the geographical location of the target user, which can be determined based on the IP address of the client computer used by the target user to access the server 50; other types of content items within the mixed content pool of interest to the target user, for example, content items previously presented to the target user; other interest information of the target user, such as may be provided to the server 50 by external third parties, such as the website FACEBOOK, who collect user interest information; and demographical information of the target user, such as age, gender, etc., that may be submitted by the target user during an optional registration with the server 50.

In still a further embodiment, the targeting options can include a total budget defining how much can be paid by a sponsor for its bids within the period of the campaign; and a daily budget, which defines a maximum a sponsor can spend to have its sponsored content items presented each day. For example, referring to FIG. 4, in the event the song Violet Hill by Coldplay is a target content item having a preset bid requirement for presentation of a sponsored content item thereafter, if the daily budget for a sponsor targeting the song Violet Hill for its sponsored content item is below the preset bid requirement, the sponsored content item of the sponsor would not be considered to be a sponsored content item, for purposes of ranking of the relevant content items to determine a related content item to be presented after the target content item.

In another embodiment, the targeting options can include a desired amount and types of exposure for the sponsored content item. The types of exposure, for example, can include views, such as where the sponsored content item is a video; plays, such as where the sponsored content item is an audio song; and the amount of time the sponsored content item is presented to a user, such as how long a webpage displayed to the user displays the sponsored content item. In addition, the type of exposure can be a function of the interests of the target user to whom the sponsored content item is presented, where the exposure is weighted more heavily based on the expected amount of interest the target user would have in the sponsored content item. For example, the presentation of a series of content items to a user having an interest in the genre of music for each of the content items of the series would constitute a greater extent of exposure than the presentation of a single content item to a user who has a relatively low level of interest in the genre of the content item, as determined from interest information for the user stored in the memory 72.

In another embodiment, the campaign can include timeframe parameters, such as a start date, an end date, and times of day and dates on which the campaign is inactive.

In a further embodiment, during creation of a sponsored content campaign, the server 50 can provide bidding information, automatically or manually, to a sponsor at the client computer 12 for guiding the bidding. The bidding information can include an estimate of the number of presentations and user engagements for a content item based on a subject bid, where the bid can be for any of the types of exposure, as set forth above.

The bidding information also can include an estimate of an optimal bid that a sponsor needs to make to maximize the likelihood that a content item receives a desired amount of presentation and user engagements, for any of the types of exposure as set forth above. A recommended bid price for the sponsored content can be determined according to the expected available supply of opportunities for presentation for a target content item and the demand for this supply, such as, for example, based on the number of sponsors desiring to obtain a portion of the available opportunities for presentation for a target content item; and the popularity of the target content item, such as measured by the number times the target content item is presented to users during a single time interval, such as a week or month. In addition, the recommended bid price can be based on the overall amount of presentations that has resulted for all bidders for the target content item, in other words, the relative exposure for sponsors targeting the target content item. For example, the relative exposure for a target content item would be high where target users are likely to engage (play) a song recommendation presented after a song that has been requested by the target users, rather than the target users requesting another song and, effectively, ignoring the presentation of the recommended song.

In still a further embodiment, a recommended bid price can be determined based on the number of users expected to be presented with a target content item, and the specificity of the targeting information. For example, the recommended bid price would be greater for a target content item having a larger expected number of users to which the target item would be presented than that for a target content item expected to be presented to a smaller number of users. For instance, the recommended bid price for a sponsored content item to be presented after a targeted rap song would exceed that for the presentation of a sponsored content item after a targeted classical song, based on classical songs being requested by less users than rap songs. In another embodiment, the recommended bid price would be greater where very specific and detailed target criteria is used, such that the sponsored content item would be presented only if a target content item satisfies all or substantially all of the targeting criteria. For example, the targeting criteria can require that a target song be by a specific artist, during a specific period of time and having certain tempo, such as a rock ballad sung by Bon Jovi during the 1980s.

In another embodiment, the server 50 can provide to the sponsor suggested content targeting information during the bidding process. The suggested content targeting information can include a level of exposure of a content item, such as the number of times a targeted content item was presented or played during a time period; a level of user acceptance of a content item thus far; and the number of bidders already having a campaign targeting the same content item.

In still another embodiment, the suggested content targeting information from the server 50 can include incentives based on purchase of a bid for one or more content items. For example, the incentive can be a price discount based on the purchase of bids for a predetermined number of specific content items to be targeted. In another alternative, a discount can be provided to a sponsor who is the first to bid on a specific content item.

In one embodiment, the processor 70 of the server 50, prior to opening of bidding for sponsorship of a content item in the mixed content pool, initially confirms whether a party is a rightful owner of the content item to be sponsored. The confirmation can be obtained based on the previous history of the relationship between the party and the sponsorship program implemented by the server 50, such as whether the party received a good standing certification based on past sponsorship agreements entered into with the program. In addition, the confirmation can be obtained based on validation of the party's identification information with a third party performing such validations. Alternatively, the confirmation can be obtained based on the popularity of the content item to be sponsored. For example, ownership of a less popular content item can be confirmed with the submission of less validating information than that required for a content item that is already very popular based on the number of times it was presented per day, week, etc. Further, the confirmation can be obtained based on a prior confirmation of the ownership of the content item where the content item had been converted from unsponsored to sponsored but the campaign for the sponsored content item had been terminated, thereby converting the sponsored content item to a unsponsored content item in the mixed content pool.

In a further embodiment, the campaign can include multiple sponsored content items, each having distinct targeting options.

In another embodiment, the fee for the bid is paid by the sponsor to the server 50 via conventional electronic payment mechanisms.

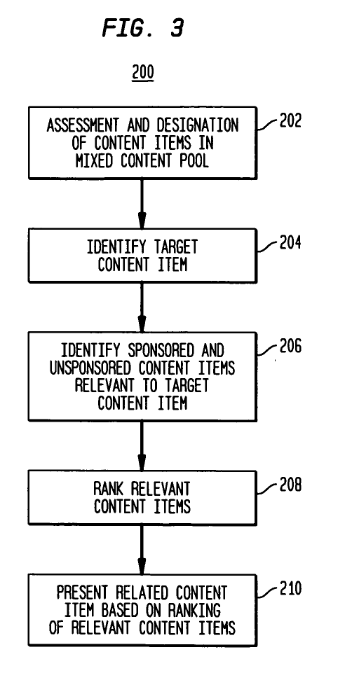

FIG. 3 illustrates steps of an exemplary method 200 for presenting a content item from a mixed content pool to a user, based on ranking of unsponsored and sponsored content items of the mixed content pool identified as being relevant to a target content item, where the ranking is based at least upon user acceptance levels of the relevant content items and where the bid price of sponsored content items identified as relevant content items impacts the ranking.

In block 202, the server 50 continuously collects information identifying various characteristics of the content items in a mixed content pool, following entry of a content item into the content pool. The server 50 is notified, or becomes aware of the existence, of a new content item available for entry into the content pool, such as by identification of the content item by a web crawler that uncovers a content item becoming available for play or download on content websites, or by a sponsor of the new content item directly contacting the server 50. For each content item in the mixed content pool, the server 50 collects and stores in the data 74 of the memory 72 information identifying the content item, such as the author, first date of distribution, genre, etc., and also sponsorship status information, such as the date on which a content item became a sponsored content item in the content pool.

In one embodiment, when a content item in the pool initially becomes a sponsored content item (“new sponsored content item”), the processor 70 of the server 50, for a predetermined time interval (“test interval”), monitors the level of acceptance by users to whom the new content item is presented. For example, when a user at the client computer 14 is accessing the server 50 and is presented by the server 50 with the new sponsored content item, the web interface of the server 50 provides that the user can supply input to the server 50 representative of whether the user finds the new sponsored content item to his or her liking, as is conventional in the art. Referring to FIG. 4, the input, for example, can be a rating between 1 and 100, where 100 is the highest level of acceptance and 1 is the lowest level of acceptance, and stored by the server 50 in the memory 72. The processor 70 averages the user acceptance levels for the new content item supplied by users during the test interval, and supplies the current, average user acceptance level to a user upon presentation of the new content item following a target content item.

In one embodiment, during the test interval, the identifying information for the new sponsored content item can be a limitation upon the presentation of the new sponsored content item by the server 50 to a user. For example, the new sponsored content item cannot be presented at all, or alternatively more than a predetermined number of times, following the presentation of a selected target content item(s). The processor 70, after a predetermined time has elapsed during the test interval, or at the end of the test interval, compares the user acceptance level for the new sponsored content item to a threshold level. Depending on the results of the comparison, the processor 70 can remove the new sponsored content item from the content pool, such as if the user acceptance level is below the threshold by at least a predetermined amount; demote the new content item, such that the bid for the new content item receives less weight in the ranking, as discussed below in connection with block 208 of the process 200; or further evaluate, automatically or manually, the new sponsored content item to determine whether the targeting criteria is appropriate. In the event the user acceptance level for the new sponsored content item is equal to or exceeds the threshold level, the new sponsored content item is no longer identified as a new sponsored content item of the mixed content pool, such that the new sponsored content item is thereafter considered for ranking and presentation purposes with other sponsored content items and unsponsored content items of the mixed content pool, as discussed below in connection with block 208 of the method 200.

In a further embodiment, the processor 70 can implement monitoring of a content item newly entered into the mixed content pool that is not sponsored over a test interval, and perform operations similar to those described above for new sponsored content items, which can result in the removal of the new content item from the mixed content pool or eliminate a “new” identification for the content item from the memory 72.

In another embodiment, the processor 70 can perform manual or automatic evaluations to control whether a content item can be sponsored to target a specific content item, such as where the owner of the target content item has an agreement with the server 50 limiting content items that can be presented thereafter to those having specific characteristics, such as specific artist(s), minimum number of presentations per day, etc.

In still a further embodiment, in block 202, the processor 70 can determine, during the bidding process, whether a content item from the mixed content pool is already so popular, for example, based on number of presentations per day, week, etc., such that sponsorship of such content item would not ordinarily increase the exposure of the content item. In such circumstances, the server 50 can provide such information to a sponsor at the client computer 12 and, instead of sponsorship, offer to provide for: (i) external advertising, promotion or marketing of the content item, based on relationships the server 50 may have with third party advertisers; and (ii) internal advertising, promotion or marketing of the content item, such as by displaying a thumbnail image of the content item on the same webpage on which the thumbnail images of the audio songs are presented to the user, as shown in FIG. 4.

In addition, in another embodiment, the processor 70 can determine, during the bidding, that it is appropriate to reallocate the sponsorship of a content item, so that more direct targeting of the content item can occur. For example, if the processor 70 determines that there are already so many sponsors whose sponsored content items are targeting a specific content item, the processor 70 can suggest that a sponsor also seeking to target the same target content item, instead, target another content item, such that the likelihood of presentation of the sponsored content item to a user increases.

In block 204, the processor 70 of the server 50 can determine when a user accessing the server 50, such as at the client computer 14, has been presented with a content item, for which a related content item is then determined from the mixed content pool and presented to the user. It is to be understood that the presentation of a content item to the user can include the display of a thumbnail image representative of the content item, such as a song, on the bottom of a webpage displayed on the computer 12, such as shown in FIG. 4. The presentation of the target content item, for example, the song War by U2, can result from a specific request by the user. Alternatively, the presentation can be based on performance of the process 200, which provides for presentation of a related content item in block 210 as discussed below.

In block 206, the processor 70 retrieves from the memory 72 identifying information for the target content item, such as artist, genre, original date of distribution, etc. Further, the processor 70 compares the identifying information for the target content item with identifying information for all other content items in the mixed content pool. The comparison is performed to identify those content items in the mixed content pool having at least some relevancy to the target content item, such that if the content item were to be presented as a recommended content item (“related content item”) to the user to which the target content item was presented, the user is expected to likely find the related content item to be of interest and, thus, play or view the related content item. Based on the comparison, the processor 70 can identify from the mixed content pool both sponsored content items and unsponsored content items that have at least some relevancy to the target content item.

In block 208, the processor 70 evaluates the identifying information for the respective relevant content items identified in block 206, and ranks the relevant content items for purposes of presenting a related content item selected from the relevant content items based on evaluation of their identifying information. In the ranking, the processor 70 determines whether the relevant content item is sponsored and, if yes, the amount of the bid for the sponsored content item. Further, as part of the ranking, the processor 70 can determine the relative relevance to the target content item, in other words, how similar is the relevant content item to the target content item, and assign an appropriate relative relevance level. In addition, the processor 70 retrieves from the data 74 in the memory 72 the user acceptance levels for respective relevant content items. In one embodiment, for each relevant content item, the amount of the bid amount, a relative relevance level and the user acceptance level are normalized; weightings are then applied to the normalized levels; and the weighted levels are summed to obtain a rank number. Thus, the weightings can be apportioned such that sponsored relevant content items, based on their bid amount, have an increased likelihood of being presented to the user when ranked against unsponsored relevant content items having similar relevance and user acceptance levels. In one embodiment, the weighting applied to the normalized bid amount is not sufficient to elevate substantially the rank number of a sponsored relevant content item having a relatively low user acceptance level. Consequently, the ranking desirably places greater weight on the user acceptance level than the bid amount level.

In one embodiment, the relative relevance level can be determined by a content matching process performed by the processor 70 using data in the memory 72 accumulated by the server 50 based on presentation of content items to users, or obtained by the server 50 from external sources. For example, the content matching process can have the processor 70 identify, from the data in the memory 72, the number of users to whom the relevant content item was presented by the server 50, and also other content items in the mixed content pool that were presented by the server 50 to the same user(s). The number of users to which the relevant content item has been presented determines the relevancy relative to another relevant content item. In another embodiment, the server 50 can evaluate identifying information received from third parties that describe a content item, such as the genre of a content item not otherwise identified with such information when entering the mixed content pool, and recommendation information from third parties specifically identifying content items to be recommended for presentation following presentation of a particular content item.

Further in block 208, the processor 70 can evaluate a historical relevance of the relevant content item in relation to the target content item, based on the identity of the creator, advertiser or sponsor of the relevant content item and if one or more of these entities match that of the target content item. Further, the processor 70 can evaluate whether the relevant content item itself previously had been presented following the presentation of the target content item. The results of such determinations can be used to determine the relative relevance level.

Also in block 208, the processor 70 can evaluate how many sponsored content items and unsponsored content items in the mixed content pool have one or more of the same identifying attributes, and use such information to determine a level of similarity of the relevant content item to all other available content items in the mixed content pool. The level of similarity can be used to determine the relative relevance level, or constitute a separately weighted factor normalized together with the bid amount, user acceptance level and relative relevance level.

In a further embodiment, in block 208, the processor 70 can determine if the number of sponsored content items of respective sponsors targeting a target content item exceeds the number of expected opportunities for presentation for the target content item. For example, there may be 1000 bidders sponsoring 1000 different, respective content items, where each of the sponsored content items specifically targets a single artist having 10 content items for which only 50 opportunities for presentation are expected to exist. If the determination is that the number of targeting sponsored content items exceeds the number of opportunities for presentation for the targeted content item, the server 50 can perform a dilution, in which the distribution of exposure for each bidder is re-allocated based on the relative bid amounts, and optionally other variables that can include popularity, user acceptance level, number of bids and historical information available from sponsors concerning the presentation and engagement of the sponsored content items, such that the number of sponsored content items targeting the target content item is reduced. Thus, for the ranking of the target content item, one or more of the sponsored content items identified as a relevant content item in block 206 are eliminated as relevant content items in block 208, such that they are not considered in the ranking. In a further embodiment, the processor 70 can recommend an increased bid amount to a sponsor if the number of sponsored content items of the sponsors which target a content item exceeds a predetermined amount.

In one embodiment, the server 50 can perform a dilution by decreasing the weighting on the bid amount for sponsored content items having bids lower than other bids; or by decreasing the weighting on the relevance level for sponsored content items whose relevance level is less than that of other sponsored content items, or which include less detailed targeting information than that of other sponsored content item. In a further embodiment, the server 50 can eliminate bid amounts that are so much less than other bid amounts competing for the same available opportunities for presentation for the same content item(s). In another embodiment, content items that have a relevancy level below a minimum required level can be eliminated as a relevant content item included in the ranking. For example, if there are first, second and third bids of $2.00, $3.00 and $5.00, respectively, for the same content item or set of content items, assuming that all other variables, such as user acceptance level and popularity, from which the ranking of a relevant content item is performed, remain constant, the first, second and third bids likely may be presented about 20%, 30% and 50% of the time, respectively, following the target content item. In actuality, however, variables such as user acceptance and popularity are unlikely to remain constant, such that actual distributions of presentations of the sponsored content items are a function of the bid amount and highly influenced by the actual success, as measured primarily by user acceptance level, of the sponsored content item within the mixed content pool.

In block 210, the server 50 can cause the related content item having the greatest rank number, as determined in block 208, to be presented to the user to whom the target content item was presented. Referring to FIG. 4, the Sponsored Song 2 is presented in the play list immediately following the song War by U2 currently being played, which became the target content item based on the specific request for play by the user. In one embodiment, one or more related content items, such as the related content item having the largest and next largest rank numbers, are presented to the user in sequence immediately after the presentation of the target content item. The related content item can be displayed with its current user acceptance level, and the user can decide to have the related content item played, or alternatively request another song to be retrieved and played. In another embodiment, the related content item can be automatically rendered, such that a related song can be played automatically after play of the song requested by the user is completed. Further, the user can supply input, via the webpage, of a user acceptance level for the related content item, upon play thereof.

In a further embodiment, the processor 70 can periodically determine whether a sponsored content item of the mixed content pool should be converted to an unsponsored item. The processor 70 can convert the sponsored content item to an unsponsored content item, such as after a campaign has terminated, if, based on the data stored in the memory 72 for the sponsored content item, the user acceptance level exceeds a threshold level or other defined minimum criteria are satisfied, such as at least a threshold number of presentations, plays or views of the sponsored content item occurs each day, week, etc.

In a further embodiment, the processor 70 can, periodically or based on requests by sponsors, retrieve data from the memory 72 representing the types of exposure for a sponsored content item; performance of any of the properties of a target content item, such as demographic information of users to whom, and how may times, the target content item was presented and the identity of the content items presented thereafter as related content items; and performance of the properties of target users, such as demographic information describing the age, gender, geographic location, etc. of the users to which the sponsored content item was presented as a related content item.

In another aspect of the invention, the content items of the mixed content pool can be search results for respective queries searched using an internet search engine. The mixed content pool includes search results actually obtained (“actual search results”) from a search on a query by the search engine; search results for which a payment has been made (“paid search results”) to have the paid search results displayed on a webpage with the actual search results for the query; and search results for which a bid amount has been paid (“sponsored search results”) to have the search results considered together with the actual and paid search results, for purposes of presentation to the user submitting the query. The server 50, which may or may not include the search engine, stores in its memory 72 information of the bid amount, the user acceptance level and relative relevance level of the search results for a specific query. The user acceptance level can be a function of the number of times the webpage to which a search result is linked was clicked through to from the search result webpage, and also how long the user displayed the linked to webpage. In a further embodiment, the processor 70 of the server 50 can determine a relative relevance level for a search result targeting a particular query based on the number of times the search result was previously obtained for the query, the number of times the query has been used in a search and the user acceptance level for the search result in relation to the user acceptance level for other search results returned for the search query. In one embodiment, the processor 70 can rank the relevant, identified actual, paid and sponsored search results targeting a search query using the bid amount, if any, the relative relevance level and the user acceptance level, for determining a related search result for presentation, similarly as described above, and thus provide for an increased likelihood of having the sponsored search result presented on the webpage containing the search results for the targeted search query based on its bid amount. In one embodiment, the processor 70 can provide that the ranked search results are listed on a webpage in a single listing, starting from the highest rank number as determined by ranking performed similarly as described above, and where the ranked search results include any of the actual, paid and sponsored search results in the mixed content pool.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for presenting content comprising:
identifying, from a content pool including unsponsored content items and sponsored content items, content items relevant to a target content item presented to a user, wherein a bid has been paid for each of the sponsored content items and wherein a bid has not been paid for the unsponsored content items;
ranking the relevant content items, wherein the ranking includes evaluating user acceptance levels of the respective relevant content items and the amount of the bid for each of the sponsored content items identified as one of the relevant content items, and wherein, in the ranking, the user acceptance level for the relevant content item is weighted more than the amount of the bid for the relevant content item; and
presenting a related content item to the user subsequent the presentation of the target content item, wherein the related content item is the relevant content item determined to have a predetermined rank by the ranking.

2. The method of claim 1, wherein the ranking includes at least one of:
determining content relevance of a first of the relevant content items to the target content item relative to the content relevance of at least one other relevant content item to the target content item;
determining historical relevance of the relevant content items to the target content item;
determining, for each of the relevant content items, how many of the other relevant content items have a similar property; or
determining, for each of the relevant content items, other contents items engaged with by users who engaged with the relevant content item.

3. The method of claim 1, wherein a recommended bid price for a first of the sponsored content items is determined as a function of at least one of (i) the number of sponsors bidding on a first target content item; (ii) popularity of the first target content item; (iii) the number of presentations of the sponsored content item over a defined time interval; (iv) the number of users expected to be presented with the first target content item over a predetermined time interval; or (v) specificity of information to be used for targeting the first target content item.

4. The method of claim 1 further comprising:
supplying to a sponsor of a first of the sponsored content items at least one of: (i) information on at least one property of a first content item targeted by the first sponsored content item, (ii) information on users to whom the first target content item has been presented; or (iii) a suggestion of at least one content item for targeting.

5. The method of claim 1 further comprising:
supplying a sponsor of a first of the sponsored content items with at least one of (i) an estimate of an amount of exposure the first sponsored content item would receive for a first bid; or (ii) an estimate of a bid that would result in a desired amount of exposure for the first sponsored content item.

6. The method of claim 1 further comprising:
converting a first of the sponsored content items in the content pool to an unsponsored content item if (i) the first sponsored content item has a user acceptance level exceeding a predetermined threshold or (ii) the first sponsored content item is presented at least a predetermined number of times within a predetermined time interval.

7. The method of claim 1, wherein the identifying further comprises:
determining whether the number of sponsored content items identified as the relevant content items exceeds a predetermined number and, if yes, at least one of (i) removing at least one of the sponsored content items as one of the relevant content items, (ii) suggesting a content item other than the target content item for targeting by the at least one of the relevant sponsored content items; or (iii) providing for marketing of the at least one of the relevant sponsored content items, using a portion of the bid for the at least one of the relevant sponsored content items.

8. The method of claim 7, wherein the removing is based on at least one of (i) the number of presentations of the relevant sponsored content items within a predetermined time interval; (ii) the bids of the respective relevant sponsored content items; or (iii) the degree of specificity of targeting information for the relevant sponsored content items.

9. The method of claim 1 further comprising:
monitoring, for a predetermined time interval, a user acceptance level of each of the sponsored content items when the sponsored content items enter into the mixed pool, and wherein during the time interval, the sponsored content items being monitored is not presented as the related content item more than a predetermined number of times.

10. The method of claim 1 further comprising:
limiting presentation of a first of the sponsored content items as the related content item, until the first sponsored content item has a user acceptance level exceeding a predetermined threshold.

11. The method of claim 1, wherein the content items include digital data.

12. A system for presenting content comprising:
a server for delivering content items to a plurality of users over a communication network, wherein the server includes or is coupled to a memory for storing sponsorship data representative of whether a content item of a content pool containing a plurality of content items is sponsored or unsponsored, wherein a bid has been paid for each of the sponsored content items and wherein a bid has not been paid for the unsponsored content items, and wherein the server includes a processor operable for:
identifying, from the content pool, content items relevant to a target content item presented to a user;
ranking the relevant content items, wherein the ranking includes evaluating user acceptance levels of the respective relevant content items and the amount of the bid for each of the sponsored contents items identified as one of the relevant content items, and wherein, in the ranking, the user acceptance level is weighted more than the amount of the bid for the relevant content items; and
providing for presentation of a related content item to the user subsequent the presentation of the target content item, wherein the related content item is the relevant content item determined to have a predetermined rank by the ranking.

13. The system of claim 12, wherein the ranking includes at least one of:
determining content relevance of a first of the relevant content items to the target content item relative to the content relevance of at least one other relevant content item to the target content item;
determining historical relevance of the relevant content items to the target content item;
determining, for each of the relevant content items, how many of the other relevant content items have a similar property; or
determining, for each of the relevant content items, other contents items engaged with by users who engaged with the relevant content item.

14. The system of claim 12, wherein the processor is operable for determining a recommended bid for a first of the sponsored content items as a function of at least one of (i) the number of sponsors bidding on a first target content item; (ii) popularity of the first target content item; (iii) the number of presentations of the sponsored content item likely to occur over a defined time interval; (iv) the number of users expected to be presented with the first target content item over a predetermined time interval; or (v) specificity of information to be used for targeting the first target content item.

15. The system of claim 12, wherein the server is operable for supplying, over the network, to a sponsor of a first of the sponsored content items at least one of: (i) information on at least one property of a first content item targeted by the first sponsored content item, (ii) information on users to whom the first target content item has been presented; or (iii) a suggestion of at least one content item for targeting.

16. The system of claim 12, wherein the server is operable for supplying, over the network, to a sponsor of a first of the sponsored content items at least one of (i) an estimate of an amount of exposure the first sponsored content item would receive for a first bid; or (ii) an estimate of a bid that would result in a desired amount of exposure for the first sponsored content item.

17. The system of claim 12, wherein the processor is operable for converting the sponsorship data for a first of the sponsored content items to that of an unsponsored content item if (i) the first sponsored content item has a user acceptance level exceeding a predetermined threshold or (ii) the first sponsored content item is presented at least a predetermined number of times within a predetermined time interval.

18. The system of claim 12, wherein the identifying further comprises:
determining whether the number of sponsored content items identified as the relevant content items exceeds a predetermined number and, if yes, at least one of (i) removing at least one of the sponsored content items as one of the relevant content items, (ii) suggesting a content item other than the target content item for targeting by the at least one of the relevant sponsored content items; or (iii) providing for marketing of the at least one of the relevant sponsored content items, using a portion of the bid for the at least one of the relevant sponsored content items.

19. The system of claim 18, wherein the removing is based on at least one of (i) the number of presentations of the relevant sponsored content items within a predetermined time interval; (ii) the bids of the respective relevant sponsored content items; or (iii) the degree of specificity of targeting information for the relevant sponsored content items.

20. The system of claim 12, wherein the processor is operable for monitoring, for a predetermined time interval, a user acceptance level of each of the sponsored content items when the sponsored content items initially enter into the mixed pool, and wherein, during the time interval, the sponsored content items being monitored is not presented as the related content item more than a predetermined number of times.

21. The system of claim 12, wherein the processor is operable for limiting presentation of a first of the sponsored content items as the related content item, until the first sponsored content item has a user acceptance level exceeding a predetermined threshold.

22. The system of claim 12, wherein the content items include digital data.

23. The system of claim 12, where the content items include at least one of audio data, video data or a combination of audio and video data.

24. A method for presenting content comprising:
identifying, from a content pool including unsponsored content items and sponsored content items, content items relevant to a target search query of a user, wherein a bid has been paid for each of the sponsored content items and wherein a bid has not been paid for the unsponsored content items;
ranking the relevant content items, wherein the ranking includes evaluating user acceptance levels of the respective relevant content items and the amount of the bid for each of the sponsored content items identified as one of the relevant content items, and wherein, in the ranking, the user acceptance level for the relevant content item is weighted more than the amount of the bid for the relevant content item; and
presenting a related content item to the user, wherein the related content item is the relevant content item determined to have a predetermined rank by the ranking.

25. The method of claim 24,
wherein the unsponsored content items include at least one of (i) search results actually obtained from a search on the target search query by a search engine and (ii) search results for which a payment has been made to have the paid search results displayed on a webpage with the search results actually obtained from the search on the target search query; and
wherein the sponsored content items include search results for which a bid amount has been paid.

26. A system for presenting content comprising:
a server for delivering content items to a plurality of users over a communication network, wherein the server includes or is coupled to a memory for storing sponsorship data representative of whether a content item of a content pool containing a plurality of content items is sponsored or unsponsored, wherein a bid has been paid for each of the sponsored content items and wherein a bid has not been paid for the unsponsored content items, and wherein the server includes a processor operable for:
identifying, from the content pool, content items relevant to a target search query of a user;
ranking the relevant content items, wherein the ranking includes evaluating user acceptance levels of the respective relevant content items and the amount of the bid for each of the sponsored contents items identified as one of the relevant content items, and wherein, in the ranking, the user acceptance level is weighted more than the amount of the bid for the relevant content items; and
providing for presentation of a related content item to the user, wherein the related content item is the relevant content item determined to have a predetermined rank by the ranking.

27. The system of claim 26,
wherein the unsponsored content items include at least one of (i) search results actually obtained from a search on the target search query by a search engine and (ii) search results for which a payment has been made to have the paid search results displayed on a webpage with the search results actually obtained from the search on the target search query; and
wherein the sponsored content items include search results for which a bid amount has been paid.
